(19) United States
(12) Patent Application Publication
(10) Pub. No.: US 2014/0219355 A1
(43) Pub. Date: Aug. 7, 2014

(54) MOTION ESTIMATION DEVICE

(71) Applicant: Semiconductor Technology Academic Research Center, Yokohama-shi (JP)

(72) Inventors: Satoshi GOTO, Kitakyushu-shi (JP); Jinjia Zhou, Kitakyushu-shi (JP); Dajiang Zhou, Kitakyushu-shi (JP)

(73) Assignee: Semiconductor Technology Academic Research Center, Yokohama-shi (JP)

(21) Appl. No.: 14/041,965

(22) Filed: Sep. 30, 2013

(30) Foreign Application Priority Data
Feb. 1, 2013 (JP) 2013-018967

(51) Int. Cl. H04N 7/36

(52) U.S. Cl. CPC H04N 19/00721
USPC 375/240.16

(57) ABSTRACT

A motion estimation device that reduces computational complexity while maintaining high prediction performance includes: block search means searching for a reference block that most approximates a prediction target block within a search range in a past direction frame F (−) or in a future direction frame F (+); search center setting means setting a search center in F (−) and F (+); and search range setting means setting a search range around the search center in F (−) and F (+), wherein the search range setting means sets a relatively large or small search range when F (0) is a P frame and switches assignment of large and small search ranges sequentially between two neighboring prediction target blocks, and the search center setting means sets a position identified by a motion vector predictor as a search center for a frame to which the relatively small search range is assigned.

### BACKGROUND OF THE INVENTION

1. Technical Field of the Invention

The present invention relates to a motion estimation technique used for coding of a motion picture and, more particularly, to a motion estimation technique capable of reducing complexity of motion estimation at a stable rate.

2. Related Art

Motion estimation (ME) is adopted in almost all mainstream motion picture compression standards, such as MPEG-2, H.264/AVC, and HEVC. ME contributes to coding efficiency considerably by removing time data redundancy between frames. According to Non-Patent document 1, ME is performed by matching a pixel block (hereinafter, a “prediction target block”) in a frame to be encoded (hereinafter, a “prediction target frame”) with a pixel block in a reference frame. Only a difference between corresponding pixel blocks accompanying displacement from the reference frame to the frame to be encoded is encoded.

In full-search ME, in order to find a pixel block that best matches the prediction target block, all the points within a search range set in the reference frame are checked. Consequently, the computational complexity of the full-search ME becomes very high. For example, according to Non-Patent document 2, it is reported that in the case where the unidirectional full-search ME is used and the search range (SR) is set to 32 in the H.264/AVC encoder, the computation time of ME accounts for 50% or more of the total computation time.

On the other hand, the prediction performance of the bidirectional ME is better compared to that of the unidirectional ME. Because of this, the necessity for the bidirectional ME increases in order to increase the compression efficiency, however, the complexity of the bidirectional ME is doubled compared to that of the unidirectional ME. Further, video contents with higher resolution, such as 1080p HD, 4K QFHD, and 8K Ultra HD (or Super Hi-Vision, SHV), require a larger search range in order to achieve a higher compression efficiency, however, the complexity of the full-search ME is in proportion to the square of the search range, and therefore, the ratio of the computation time of ME becomes further larger. Consequently, a reduction in the computational complexity of ME is a critical technical problem.

Accordingly, a variety of methods have been developed hitherto in order to reduce the complexity of ME while maintaining coding performance. As one methods, a new search pattern is applied in place of the full-search in order to reduce the number of search points to be checked in the search range. As representative methods in this category, a three step search (Non-Patent document 3), a four step search (Non-Patent document 4), a diamond search (Non-Patent document 5), and a cross diamond search (Non-Patent document 6) are known.

On the other hand, as algorithms in which the search range (SR) is reduced to reduce the complexity of the full-search ME, several dynamic SR selection algorithms are disclosed (Non-Patent documents 13 to 16). The basic idea of these algorithms is that the search range is assigned adaptively in accordance with the predicted motion intensity, and therefore, it is possible to suppress the average computation time because of the small search range.

In Non-Patent document 17, the dynamic SR adjustment algorithm capable of stably reducing memory traffic is disclosed.

### NON-PATENT DOCUMENTS

Non-Patent Document 1: T. Wiegand, G. J. Sullivan, G. Bjntegaard, and A. Luthra, “Overview of the H.264/AVC video coding standard,” IEEE Transactions on Circuits and Systems for Video Technology, vol. 13, no. 7, pp. 560-576, July.
Non-Patent Document 2: W. I. Chong, B. Jeon, and J. Jeong, “Fast motion estimation with modified diamond search for variable motion block sizes,” in IEEE International Conference on Image Processing, 2003, pp. 24-17
Non-Patent Document 3: R. Li, B. Zeng, and M. L. Liou, “A new three-step search algorithm for block motion estimation,” IEEE Transactions on Circuits and Systems for Video Technology, vol. 4, no. 4, p. 438442, August 1994
Non-Patent Document 4: L. M. Po and W. C. Ma, “A novel four-step search algorithm for fast block motion estimation,” IEEE Transactions on Circuits and Systems for Video Technology, vol. 6, no. 3, p. 313317, June 1996
Non-Patent Document 5: S. Zhu and K.-K. Ma, “A new diamond search algorithm for fast block matching motion estimation,” IEEE Transactions on Image Processing, Vol. 9, no. 2, p. 287290, February 2000
Non-Patent Document 6: C. H. Cheung and L. M. Po, “A novel cross-diamond search algorithm for fast block motion estimation,” IEEE Transactions on Circuits and Systems for Video Technology, vol. 12, no. 12, p. 11681177, December 2002
Non-Patent Document 7: L. Ding, W. Chen, P. Tsung, and L. Chen, “A 212mpixels/s 4096×2160p multiview video encoder chip for 3D/quad HDTV applications,” in International Solid-State Circuits Conference, 2009, pp. 154-155
Non-Patent Document 8: Y. Lin, D. Li, C. Lin, T. Kuo, and S. Wu, “A 242 mw 10 mm2 1080p H.264/AVC high-profile encoder chip,” in International Solid-State Circuits Conference, 2008, pp. 314-315
Non-Patent Document 9: P. Tsung, W. Chen, L. Ding, S. Chien, and L. Chen, “Cache-based integer motion/disparity estimation for quad-hd h.264/avc and hd multiview video coding,” in IEEE International Conference on Acoustics, Speech and Signal Processing, 2009, pp. 2013-2016
Non-Patent Document 10: Y. Lin, C. Lin, T. Kuo, and T. Chang, “A hardware-efficient H.264/AVC motion-estimation design for high-definition video,” IEEE Transactions on Circuits and Systems for Video Technology, vol. 35, no. 6, pp. 1526-1535, July 2008
Non-Patent Document 11: X. Bao, D. Zhou, P. Liu, and S. Goto, “An advanced hierarchical motion estimation scheme with lossless frame recompression and early level termination for beyond high definition video coding,” IEEE Transactions on Multimedia, pp. 1520-9210, October 2011
Non-Patent Document 12: H. Y. Peng and T. L. Yu, “Efficient hierarchical motion estimation algorithm and its VLSI architecture,” IEEE Transactions on Circuits and Systems for Video Technology, vol. 16, no. 10, pp. 1385-1398, October 2008
Non-Patent Document 13: C. C. Lou, M. Hsieh, S. W. Lee, and C. C. J. Kuo, “Adaptive motion search range prediction for video encoding,” IEEE Transactions on Circuits and Systems for Video Technology, vol. 20, no. 12, p. 19031908, December 2010
Non-Patent Document 14: S. Goel, Y Ismail, and M. A. Bayoumi, “Adaptive search window size algorithm for fast motion estimation in H.264/AVC standard,” in Midwest Symposium on Circuits and Systems, 2005, p. 15571560
Non-Patent Document 15: Z. Chen, Q. Liu, T. Ikenaga, and S. Goto, “A motion vector difference based self-incremental adaptive search range algorithm for variable block size motion estimation,” in IEEE International Conference on Image Processing, 2008, pp. 1988-1991
Non-Patent Document 16: G. L. Li and M. J. Chen, “Adaptive search range decision and early termination for multiple reference frame motion estimation for H.264,” IEICE Transactions on Communication, vol. E89-B, no. 1, pp. 250-253, July 2006
Non-Patent Document 17: J. Jung and J. Kim, “A dynamic search range algorithm for stabilized reduction of memory traffic in video encoder,” IEEE Transactions on Circuits and Systems for Video Technology, vol. 20, no. 7, pp. 1041-1046, July 2010
Non-Patent Document 18: C. Kao and Y Lin, “A memory-efficient and highly parallel architecture for variable block size integer motion estimation in H.264/AVC,” IEEE Transactions on Very Large Scale Integration Systems, vol. 18, no. 6, pp. 1063-8210, June 2010
Non-Patent Document 19: H.264/AVC reference software version JM 17.2. [Online]. Available: <URL:http://iphome.hhi.de/suchring/tml>
Non-Patent Document 20: JCT-VC HEVC reference software version HM 7.0. [Online]. Available: <URL:https://hevc.hhi.fraunhofer.de/svn/svn HEVCSoftware>
Non-Patent Document 21: C. Chen, S. Chien, Y. Huang, T. Chen, T. Wang, and L. Chen, “Analysis and architecture design of variable block-size motion estimation for H.264/AVC,” IEEE Transactions on Circuits and Systems for Video Technology, vol. 53, no. 3, pp. 1549-8328, March 2006
Non-Patent Document 22: G. Bjontegaard, “Calculation of average PSNR differences between RD curves,” ITU-T SG16/Q6, 13th VCEG meeting, April 2001
Non-Patent Document 23: F. Bossen, “Common test conditions and software reference configurations,” JCTVC-H1100, Joint Collaborative Team on Video Coding (JCTVC) of ITU-T SG16 WP3 and ISO/IEC JTC1/SC29AVG11, February 2012
Non-Patent Document 24: J. Zhou, D. Zhou, and S. Goto, “Interlaced asymmetric search range assignment for bidirectional motion estimation,” in IEEE International Conference on Image Processing, 2012, in press

### SUMMARY OF THE INVENTION

Each method of the three step search (Non-Patent document 3), the four step search (Non-Patent document 4), the diamond search (Non-Patent document 5), and the cross diamond search (Non-Patent document 6) is normally capable of effectively reducing the amount of computation, and therefore, it is possible to increase the rate of a software-based encoder. However, these new search patterns are normally accompanied by an irregular data processing flow, and therefore, at the time of hardware implementation, there is a problem that pipelining or parallelization becomes difficult to achieve.

In actuality, almost all of the hardware ME architectures, in particular, the ME architectures implemented in the video encoder chip (Non-Patent documents 7, 8) launched in recent years are based on the full-search ME or the revised version of the full-search ME. In Non-Patent documents 7 and 9, candidates based on the search center derivation method are applied in order to improve the performance of the full-search ME of a comparatively small search range. In the hierarchical ME architecture disclosed in Non-Patent documents 10, 11, and 12, in order to support a large search window while reducing complexity, the full-search ME is performed in each hierarchy by using a reference block hierarchically down-sampled at a plurality of levels.

The dynamic SR selection algorithm disclosed in Non-Patent documents 13 to 16 has such a problem that it is not possible to guarantee to suppress complexity stably. Consequently, it is not possible to improve the worst-case performance that is important in a real-time system.

In the dynamic SR adjustment algorithm disclosed in Non-Patent document 17, it is possible to reduce memory traffic stably, however, there is a problem that the computational complexity still fluctuates between blocks.

An object of the present invention is to provide a motion estimation device capable of reducing the computational complexity of ME at a stable rate while maintaining high prediction performance.

A motion estimation device according to the first aspect of the invention performs estimation of a motion vector of a prediction target block included in a prediction target frame, in a motion picture consisting of a plurality of frames arranged side by side in the time order, the prediction target frame being a frame of the plurality of frames for which prediction of a motion vector is performed, and the prediction target block being one of pixel blocks set by dividing the prediction target frame. The motion estimation device includes: block search means for searching for a reference block, that most approximates the prediction target block of the prediction target frame, within a predetermined search range in a frame in the past direction relative to the prediction target frame or within a predetermined search range in a frame in the future direction relative to the prediction target frame; search center setting means for setting a search center when the block search means performs a search regarding the prediction target block in the frame in the past direction and in the frame in the future direction; and search range setting means for setting the search range around the search center regarding the prediction target block in the frame in the past direction and in the frame in the future direction, wherein the search range setting means sets a large search range SR. L having a relatively large size or a small search range SR. S having a relatively small size around the search center and switches assignment of the large search range SR. L and the small search range SR. S sequentially between the two neighboring prediction target blocks, and the search center setting means sets a position identified by a motion vector predictor calculated from a motion vector in a pixel block in the prediction target frame, for which pixel block a motion vector is predicted earlier, as the search center at least for the frame to which the small search range SR. S is assigned by the search range setting means.

With the configuration of the motion estimation device of the present invention, it is possible to perform a search for a motion vector by the above-described AASRA-P scheme.

The “frame” may be a frame of an original video sequence and may also be a frame generated by down-sampling each frame of the original video sequence when performing the hierarchical search. The “pixel block” is a pixel block set by dividing the interior of the frame, such as a macroblock (MB) and a largest coding unit (LOU).

In the motion estimation device according to the second aspect of the invention, the search range setting means sets the large search range SR. L to one of the frame in the past direction and the frame in the future direction and sets the small search range SR. S to the other in the case where the prediction target frame is a bidirectional prediction frame, and the search range setting means further sequentially switches assignment of the large search range SR. L and the small search range SR. S to the frame in the past direction and to the frame in the future direction between two neighboring prediction target blocks.

With this configuration, it is possible for the motion estimation device to perform a search for a motion vector by the above-described AASRA-B scheme.

In the motion estimation device according to the third aspect of the invention, the pixel blocks in the prediction target frame are divided into units of block pairs, which is a pair of an odd-numbered pixel block and an even-numbered pixel block adjacent thereto, and the block pair including the prediction target block is taken as a prediction target block pair, the search range setting means sets the small search range SR. S to both the frame in the past direction and the frame in the future direction for one of the prediction target blocks in the prediction target block pair, and sets the large search range SR. L to one of the frame in the past direction and the frame in the future direction and sets the small search range SR. S to the other for the other prediction target block in the case where the prediction target frame is a bidirectional prediction frame, and the search range setting means further switches assignment of the small search range SR. S and the large search range SR. L sequentially so that the combinations (of the parity and the search direction) of the prediction target blocks to which the large search range SR. L is assigned in the prediction target block pair are different between all the four successive prediction target block pairs.

With this configuration, it is possible for the motion estimation device to perform a search for a motion vector by the above-described AASRA-PB scheme.

In the motion estimation device according to the fourth aspect of the invention, p (p is an integer not less than 2) successive pixel blocks are taken to be one set of block group and the block set including the prediction target block is taken to be a prediction target block group, the search range setting means switches the assignment of the large search range SR. L and the small search range SR. S sequentially between the two neighboring prediction target block groups, and the search center setting means sets the same search center for each of the prediction target block groups at least for the frame to which the small search range SR. S is assigned by the search range setting means and at the same time, sets a position identified by a motion vector predictor calculated from a motion vector in a pixel block neighboring the prediction target block group in the prediction target frame and for which a motion vector is predicted earlier than the prediction target block group.

With this configuration, in the AASRA-P scheme, it is possible to achieve parallelization in which the motion search is performed for p pixel blocks in parallel.

In the motion estimation device according to the fifth aspect of the invention, the search range setting means sets the large search range SR. L to one of the frame in the past direction and the frame in the future direction and sets the small search range SR. S to the other for the prediction target block in the case where the prediction target frame is a bidirectional prediction frame, and the search range setting means further sequentially switches assignment of the large search range SR. L and the small search range SR. S to the frame in the past direction and to the frame in the future direction between the two neighboring prediction target block groups.

With this configuration, in the AASRA-B scheme, it is possible to achieve parallelization in which the motion search is performed for p pixel blocks in parallel.

In the motion estimation device according to the sixth aspect of the invention, the pixel block group in the prediction target frame is divided into units of block group pairs, which is a pair of an odd-numbered pixel block group and an even-numbered pixel block group adjacent thereto, and the block group pair including the prediction target block group is taken as a prediction target block group pair, the search range setting means sets the small search range SR. S to both the frame in the past direction and the frame in the future direction for one of the prediction target block groups in the prediction target block group pair and sets the large search range SR. L to one of the frame in the past direction and the frame in the future direction and sets the small search range SR. S to the other for the other prediction target block group in the case where the prediction target frame is a bidirectional prediction frame, and the search range setting means further switches assignment of the small search range SR. S and the large search range SR. L sequentially so that the combinations (of the parity and the search direction) of the prediction target block groups to which the large search range SR. L is assigned in the prediction target block group pair are different between all the four successive prediction target block group pairs.

With this configuration, in the AASRA-PB scheme, it is possible to achieve parallelization in which the motion search is performed for p pixel blocks in parallel.

A storage medium stores an estimation program which makes a computer to operate as the above-mentioned motion estimation device.

As described above, according to the present invention, it is possible to provide a motion estimation device capable of reducing the computational complexity of ME at a stable rate while maintaining high prediction performance. Because the rate of computational complexity is stable, it is easy to achieve pipelining or parallelization and hardware implement is also easy.

As a result of the actual experiment, with the motion estimation device to which the first and the second aspects of the present invention are applied, it is possible to achieve a reduction in computational complexity by 46% or more compared to that to which the full-search ME is applied, and it is possible for ME to catch up with a high motion in both the directions. Further, with the motion estimation device to which the third aspect of the present invention is applied, a reduction to a certain extent in coding performance is observed, however, it is proved that a reduction in computational complexity by 70% or more can be achieved compared to the full-search ME.

### BRIEF DESCRIPTION OF THE DRAWINGS

FIG. 1 is a diagram illustrating a method for assigning a search range in an AASRA (AASRA-B) scheme for bidirectional ME;

FIG. 2A is a diagram illustrating MV catch-up-with capability of an AASRA method;

FIG. 2B is a diagram illustrating the MV catch-up-with capability in an SR. S direction of an ASRA method;

FIG. 3 is a diagram illustrating a method for assigning a search range in an AASRA (AASRA-P) scheme for unidirectional ME;

FIG. 4 is a diagram illustrating a method for assigning a search range in a combined (AASRA-PB) scheme of AASRA-B and AASRA-P;

FIG. 5 is a diagram illustrating a method for switching assignment of SR. L in AASRA-PB;

FIG. 6 is a diagram illustrating an example of a motion picture encoder that uses a motion estimation device according to a first embodiment of the present invention;

FIG. 7 is a block diagram illustrating a configuration of the motion estimation device according to the first embodiment of the present invention;

FIG. 8 is a flowchart showing a general operation of the motion estimation device of the first embodiment;

FIG. 9A to FIG. 9C are a flowchart showing search range assignment processing in FIG. 8;

FIG. 10 is a diagram illustrating a memory access sequence of a snake scan;

FIG. 11A to FIG. 11D are diagrams illustrating a change in coded bit rate when the size of SR is changed in a motion estimation device using full-search ME and a video encoder using the motion estimation device of the present embodiment;

FIG. 12A and FIG. 12B are flowcharts showing search range assignment processing for a P frame and a B frame in a motion estimation device 8 according to a second embodiment;

FIG. 13 is a diagram for explaining how to determine a search center of AASRA based on IMNPDR;

FIG. 14 is a block diagram illustrating a configuration of a motion estimation device according to a third embodiment of the present invention;

FIG. 15 is a flowchart showing a general operation of the motion estimation device according to the third embodiment;

FIG. 16 is a diagram illustrating relative hardware parallelism necessary to achieve equivalent throughput in PMRME and PMRME to which the AASRA scheme is applied.

### DESCRIPTION OF THE EMBODIMENTS

In the motion estimation device according to the present invention, an alternating asymmetric SR assignment (ASSRA) scheme that the inventors of the present invention have newly developed is applied. AASRA includes three schemes of AASRA for bidirectional ME (AASRA-B), AASRA for unidirectional ME (AASRA-P), and AASRA that is a combination of AASRA-B and AASRA-P (AASRA-PB). First, the basic principle of these schemes is explained.

(1) AASRA for Bidirectional ME (AASRA-B)

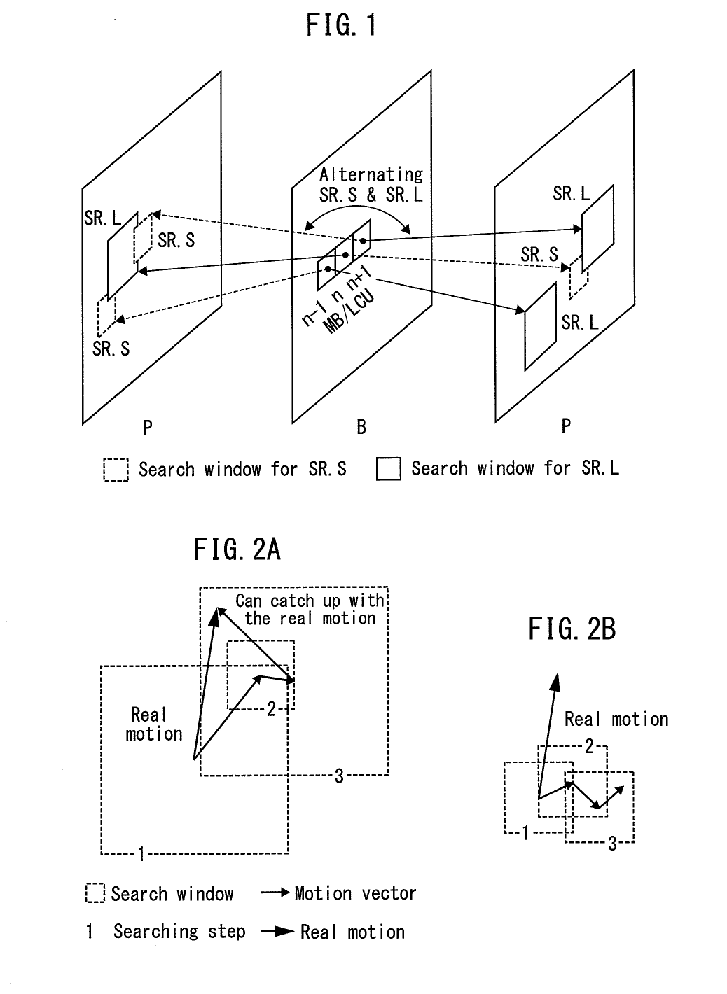

In the bidirectional prediction frame (B frame), motion estimation is performed by using references in both the directions of the past direction and the future direction. Statistically, as illustrated in FIG. 1, the two closest reference frames (one frame on the past side and the other on the future side) are most important for coding efficiency. In the implementation in the high-throughput video encoder disclosed in recent years (Non-Patent documents 7, 8), in order to reduce the computational complexity and to maintain the memory bandwidth in an appropriate range, only the closest reference frames are searched for. Compared to the unidirectional prediction frame (P frame) in which only one direction is searched for, in the B frame, the reference frames in the number twice that in the P frame are searched for (because of two directions), and therefore, the degree of importance of the reference frame in each direction is lower compared to that in the P frame. Because of this, in AASRA-B, the total amount of computation is reduced by applying a “weaker ME” to one of the reference directions of the B frame.

The computational complexity of ME depends on the size of the search range (SR), and therefore, in the asymmetric SR assignment: ASRA) method, a relatively large search range (SR. L) is assigned to one of the directions and a relatively small search range (SR. S) is assigned to the other direction at all times. However, for a high-motion video sequence that requires a search range larger than SR. S, in ASRA, there is a possibility that inaccurate motion estimation is performed in the direction of SR. S, and therefore, there is a possibility that a considerable reduction in coding performance may occur.

In order to overcome such drawbacks, in the alternating asymmetric SR assignment (AASRA) scheme, in place of the fixed assignment of two SRs (SR. L, SR. S) to the two directions as in ASRA, assignment for use of SR. S and SR. L is switched in the past direction and in the future direction once for each pixel block (MB: macroblock) or each LCU (largest Coding Unit) as illustrated in FIG. 1. In other words, in the case where SR. L is assigned to a certain reference direction in a pixel block (N), SR. S has to be assigned to the reference direction in a pixel block (N+1). Further, in a pixel block (N+2), SR. L has to be assigned to the reference direction. The converse of this is also true.

When implementing specifically, as the search center of SR. L, either of the zero vector and the motion vector predictor (MVP) (for example, see ITU-T H.264, “SERIES H: AUDIOVISUAL AND MULTIMEDIA SYSTEMS” (January, 2012)) may be used, however, as the search center of SR. S, MVP should be used at all times.

Theoretically, AASRA-B has advantages as follows.

Firstly, in each pixel block, the ME complexity is stable. This is important to secure the worst-case performance. When the size ratio between SR. L and SR. S is sufficiently large, the ratio of reduction in complexity in the case where SR. L is assigned to both the directions (the conventional full-search ME) is about 50%. Due to this, the variation in the degree of coding complexity between the B frame and the P frame is also reduced. This will lead to improvement of the hardware use efficiency in coding of the P frame in a real-time system.

Secondly, in each direction, a search using SR. L is performed always before a search using SR. S. With the search using SR. L, it is possible to perform accurate motion estimation for a high motion and there is also a tendency for the search using SR. L to provide the next search using SR. S with a search center suitable for matching. Consequently, it is predicted that favorable motion estimation is performed even if the size of SR. S is not so large by utilizing the motion vector (MV) obtained by the search using SR. L to determine the search center of the next search using SR. S. As a result, in contrast to ASRA, it can be said that in AASRA-B, the equal and sufficient degree of importance is given to both the search directions. In particular, in the case where the search center of SR. L is taken to be MVP, it is possible to capture the motion vector even for a real motion larger than SR. L. in AASRA-B. This is similar to that the search using SR. L is always performed as illustrated in FIG. 2A and is equivalent to that cumulative multiple searches for two or more pixel blocks are performed. On the other hand, as illustrated in FIG. 2B, even if similar cumulative multiple searches are performed by using SR. S, the same effect is not obtained.

Compared to the bidirectional full-search ME taking all the search ranges as SR. L, AASRA-B reduces the ME complexity to (1−(SR. S/SR. L)²)/2 times the original ME complexity in terms of the number of search points. In the case where SR. S²<<SR. L², the ratio of reduction in computational complexity is about 50%.

(2) AASRA for Unidirectional ME (AASRA-P)

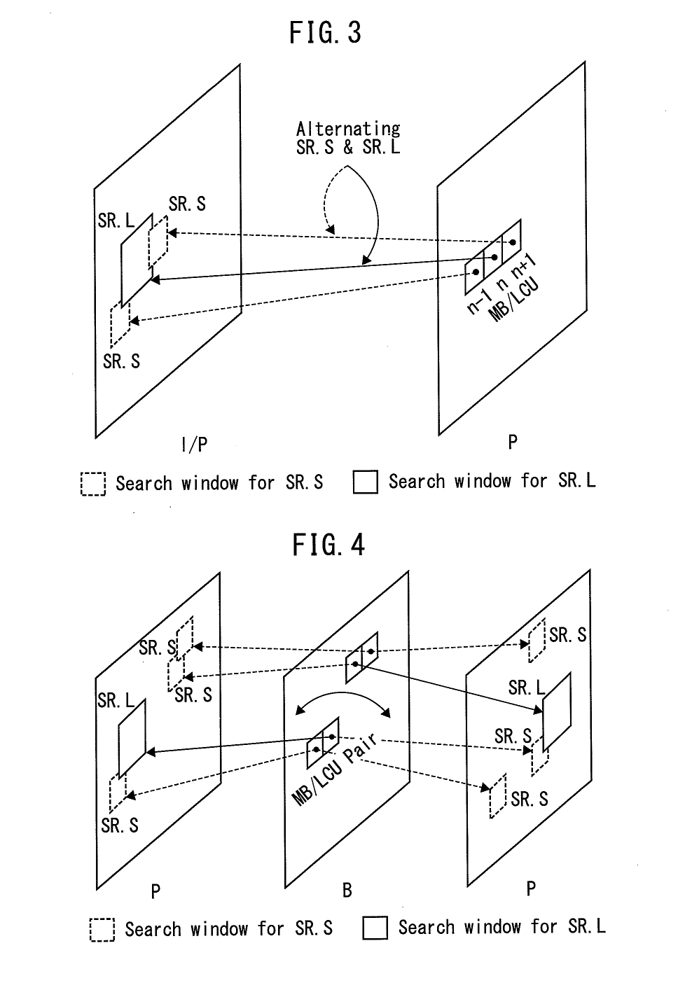

AASRA-B is the method for the bidirectional ME, however, it is also possible to apply the same idea as that of the alternating SR assignment to the P frame whose reference direction is only one. In AASRA for the unidirectional ME (AASRA-P), at first, SR. L is assigned to the search range of the top pixel block in the frame, and switching of the search range to SR. L, returning to SR. L, . . . are performed alternately in a repeated manner each time the prediction target block moves to the neighboring pixel block. FIG. 3 illustrates a method for assigning a search range in AASRA-P. This is the same operation as that on the unidirectional side in AASRA-B (FIG. 1). The ME computational complexity of each pixel block changes periodically together with the size of the assigned search range, however, the computational complexity for a pair of two pixel blocks adjacent to each other (hereinafter, referred to as a “block pair”) is stable.

Compared to the unidirectional full-search ME taking all the search ranges as SR. L, AASRA-P reduces the ME complexity to (1−(SR. S/SR. L)²)/2 times the original ME complexity in terms of the number of search points. In the case where SR. S²<<SR. L², the ratio of reduction in computational complexity is about 50%. This is the same as the ratio of reduction of AASRA-B for the B frame.

(3) Combination of AASRA-B and AASRA-P (AASRA-PB)

AASRA-B and AASRA-P are characterized in that SR. L and SR. S are switched in the two-dimensional space (of the reference direction and the index of pixel block), however, for the bidirectional ME, it is possible to couple the two schemes of AASRA-B and AASRA-P in order to further reduce computational complexity.

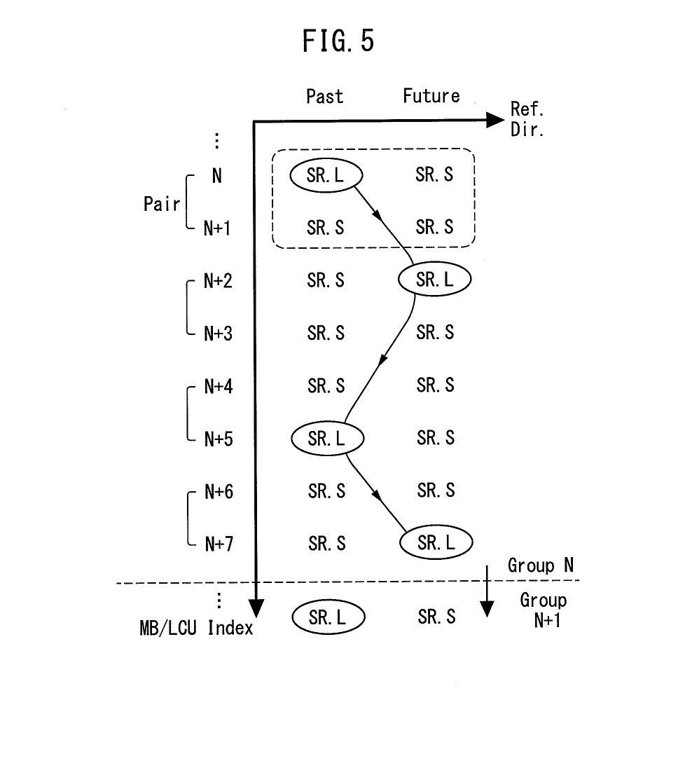

FIG. 4 illustrates a method for assigning a search range in the combined scheme (AASRA-PB) of AASRA-B and AASRA-P. A pair of two successive pixel blocks (block pair) (an odd-numbered pixel block and an even-numbered pixel block adjacent thereto) is regarded as a minimum unit in search range assignment processing. In one block pair, by the bidirectional search operation of the two pixel blocks, SR. L is assigned only to the search range in one of the search directions of one pixel block and SR. S is assigned to the remaining three search ranges. (The parity of the index and the search direction of the pixel block) to which SR. L is assigned in the block pair are switched between neighboring block pairs as illustrated in FIG. 5. In other words, (the parity of the index and the search direction of the pixel block) to which SR. L is assigned are set so as to be different from one another between all the four successive block pairs and switching of assignment of SR. L is performed periodically with the four successive block pairs being taken as one cycle.

Compared to the unidirectional full-search ME taking all the search ranges as SR. L, AASRA-PB reduces the ME complexity to (3−3(SR. S/SR. L)²)/4 times the original ME complexity in terms of the number of search points. In the case where the size of SR. S is set to ¼ of the size of SR. L, the ratio of reduction in computational complexity is about 70%.

AASRA-PB has an advantage that the computational complexity can be reduced more than AASRA-B for the bidirectional search, and one more advantage of AASRA-PB is that the computational complexity can be balanced in the ME computation in the P frame and in the B frame. In the coding workload including both types of frames, if AASRA-B is applied to the B frame, the original computational complexity of the P frame is already smaller than the computational complexity of the B frame to which AASRA-B is applied, and therefore, even if AASRA-P is applied to the P frame, it is not possible to reduce the ME computational complexity in the worst case. However, in the case where AASRA-P and AASRA-PB are applied to the P frame and the B frame, respectively, it is possible to make the computational complexity minimum both in the average case and in the worst case.

Hereinafter, a motion estimation device of an embodiment of the present invention is explained with reference to the drawings.

(1) General Configuration of Video Encoder Using Motion Estimation Device

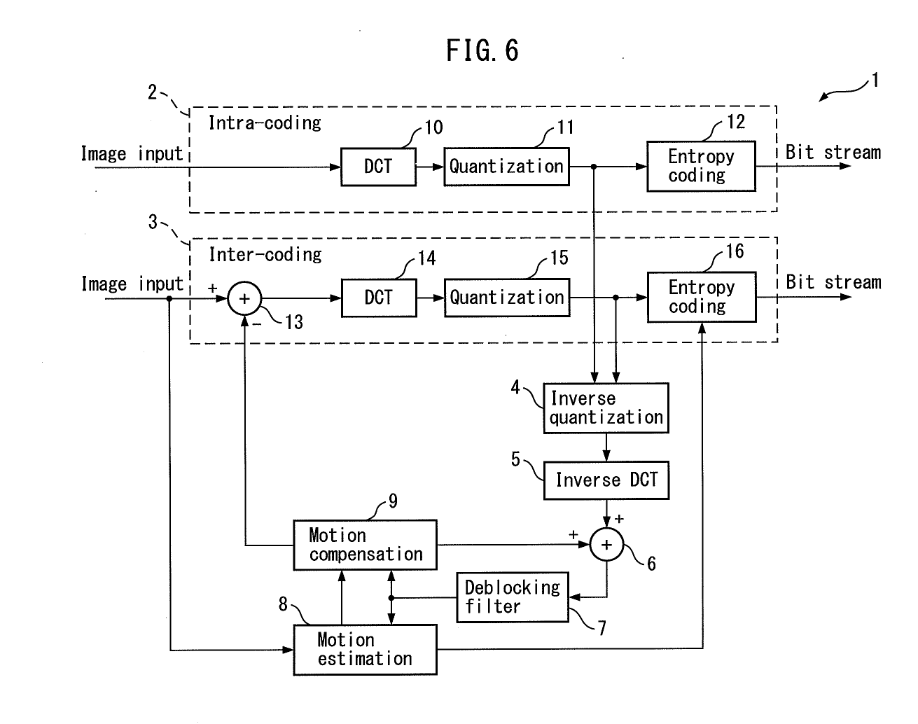

FIG. 6 is a diagram illustrating a video encoder using a motion estimation device according to a first embodiment of the present invention. In FIG. 6, as an example of the video encoder, a normal MPEG-4 encoder is illustrated, however, the application range of the motion estimation device according to the present invention is not limited to this. It may also be possible to configure the video encoder and the motion estimation device in the present embodiment by using hardware, such as a microcomputer, a reconfigurable logic device, and an ASIC (Application Specific Integrated Circuit). Further, it may also be possible to implement the video encoder and the motion estimation device in the present embodiment by configuring them as computer programs and recording the programs in a recording medium, and by causing a computer to read and execute the computer programs recorded in the recording medium.

In the following embodiment, it is assumed that a motion picture encoded by a video encoder 1 consists of a plurality of frames arranged in the time order (VOP: Video Object Plane), the frame of each VOP for which prediction of the motion vector is performed is taken to be a prediction target frame F (0), and the block set by dividing the interior of the prediction object frame F (0) into rectangles of a predetermined size is taken to be a pixel block. As the pixel block, the macroblock (MB) or the largest coding unit (LCU) is used, however, it is assumed that the pixel block is the macroblock here. The size of the pixel block is assumed to be arbitrary.

The video encoder 1 includes an intra-coding unit 2, an inter-coding unit 3, an inverse quantizer 4, an inverse DCT operator 5, an adder 6, a deblocking filter 7, a motion estimation device 8 according to the present invention, and a motion compensator 9.

The intra-coding unit 2 performs intra-coding for an I frame. The intra-coding unit 2 includes a DCT operator 10, a quantizer 11, and an entropy encoder 12. The DCT operator 10 divides the frame of an input video image into macroblocks (MB), basic processing units, and performs discrete cosine transform (DCT) on each MB. The quantizer 11 quantizes each macroblock having been subjected to DCT. The entropy encoder 12 performs variable length coding on the quantized DCT coefficient and the quantized width of each macroblock and outputs them as a coded bit stream.

On the other hand, the inter-coding unit 3 performs inter-coding of the P frame and the B frame. The inter coding unit 3 includes an adder 13, a DCT operator 14, a quantizer 15, and an entropy encoder 16. First, the motion estimation device 8 detects a macroblock (hereinafter referred to as a “prediction macroblock”) that most approximates the prediction target block (error is the smallest) by the motion vector prediction by block matching from the other frames (reference frames) neighboring in terms of time for the prediction target frame including the macroblock (prediction target block) to be encoded. The vector from the prediction target block to the prediction macroblock is the motion vector (MV). Next, the motion compensator 9 compensates for the motion of the reference frame and acquires the optimum prediction macroblock based on the detected motion vector. Next, the adder 13 finds a difference between the prediction target macroblock and the prediction macroblock corresponding thereto. The DCT operator 14 performs DCT on the difference signal and the quantizer 15 quantizes the DCT coefficient. The entropy encoder 16 performs variable length coding of the quantized DCT coefficient together with the motion vector and the quantized width.

(2) Configuration of Motion Estimation Device

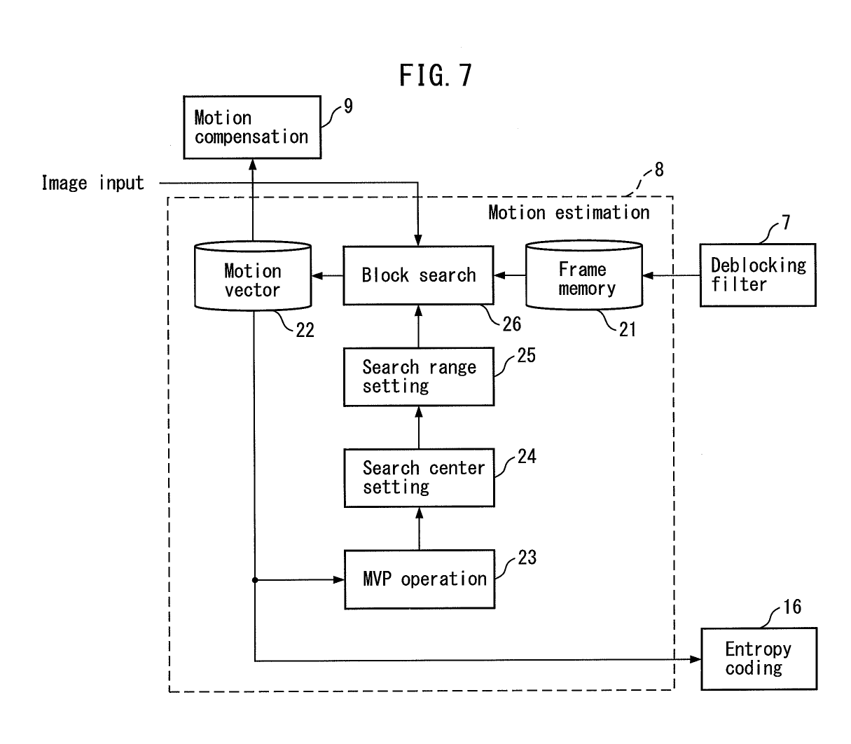

FIG. 7 is a block diagram illustrating the configuration of the motion estimation device according to the first embodiment of the present invention, corresponding to the motion estimation device 8 in FIG. 1. The motion estimation device 8 includes a frame memory 21, a motion vector storage unit 22, a motion vector predictor (MVP) operation unit 23, a search center setting unit 24, a search range setting unit 25, and a block search unit 26. The motion estimation device 8 estimates the motion vector for the prediction target block by sequentially taking each pixel block set by dividing the interior of the prediction target frame F (0) as a prediction target block for which the motion vector is predicted.

The frame memory 21 temporarily stores a decoded frame obtained by decoding the frame of the motion picture encoded into the quantized DTC coefficient in the intra-coding unit 2 or the inter-coding unit 3 by the inverse quantizer 4, the inverse DCT operator 5, the adder 6, and the deblocking filter 7. The motion vector storage unit 22 temporarily stores the motion vector of each pixel block obtained by the block search.

The block search unit 26 searches for a reference block that most approximates the prediction target block within a predetermined search range in a reference frame F (−) in the past direction relative to the prediction target frame F (0) or within a predetermined search range in a reference frame F (+) in the future direction relative thereto for the prediction target block in the prediction target frame F (0) read from the frame memory 21.

The motion vector predictor (MVP) operation unit 23 calculates a motion vector predictor (MVP) from the motion vector of the block around the prediction target block. The search center setting unit 24 sets a search center used when the block search unit 26 performs a search in the reference frames F (−) and F (+) for the prediction target block. The search range setting unit 25 sets a search range around the search center in the reference frames F (−) and F (+) for the prediction target block.

In the present embodiment, it is assumed that the search range setting unit 25 assigns the search range (SR) based on the AASRA-P scheme in the case where the prediction target frame F (0) is the P frame (unidirectional prediction frame), and assigns the search range (SR) based on the AASRA-B scheme in the case where the prediction target frame F (0) is the B frame (bidirectional prediction frame). In other words, in the case where the prediction target frame F (0) is the P frame, the search range setting unit 25 sets the search range SR. L having a relatively large size or the search range SR. S having a relatively small size to the reference frame F (−) for the prediction target block. At this time, assignment of the search range SR. L and the search range SR. S is switched sequentially between two neighboring prediction target blocks.

On the other hand, in the case where the prediction target frame F (0) is the B frame, the search range setting unit 25 sets the search range SR. L to one of the reference frames F (−) and F (+) for the prediction target block and sets the search range SR. S to the other. At this time, assignment of the search ranges SR. L and SR. S to the frames F (−) and F (+) is switched sequentially between two neighboring prediction target blocks.

The search center setting unit 24 sets the position identified by the motion vector predictor calculated by the MVP operation unit 23 as the search center for the reference frame to which the search range SR. S is assigned by the search range setting unit 25. Further, the search center setting unit 24 sets the position identified by the motion vector predictor calculated by the MVP operation unit 23 or the 0 vector as the search center for the reference frame to which the search range SR. L is assigned by the search range setting unit 25.

(3) Operation of Motion Estimation Device

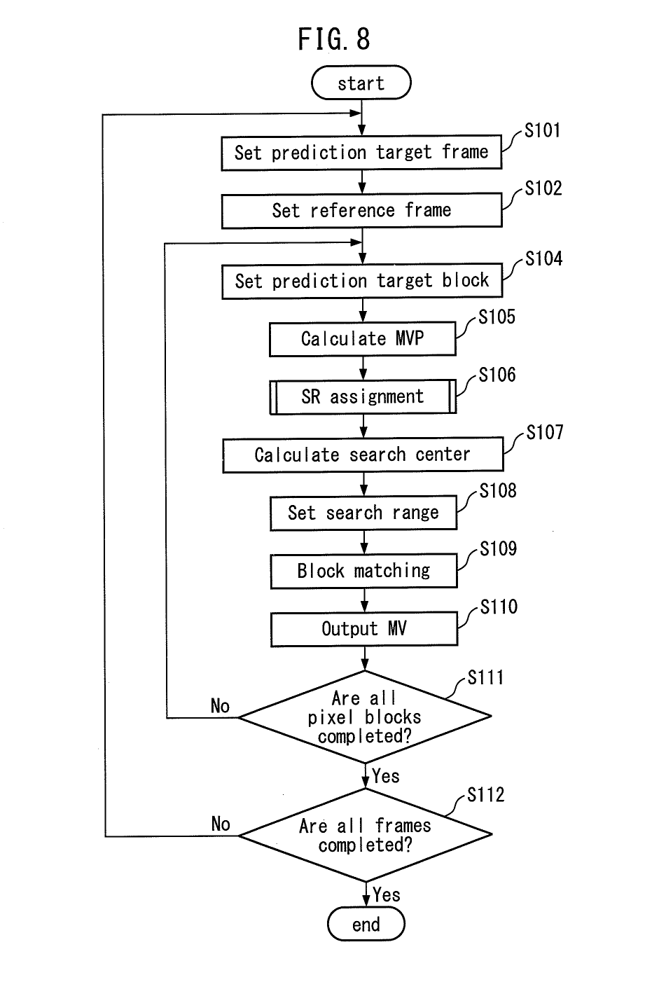

Next, the operation of the motion estimation device 8 of the present embodiment is explained. FIG. 8 is a flowchart showing the general operation (motion estimation processing) of the motion estimation device 8 of the present embodiment.

First, the block search unit 26 sets the frame number of the prediction target frame F (0) (S101). Next, the block search unit 26 sets the frame number of the reference frame according to the kind of the prediction target frame F (0) (S102). For example, in the case where the kind of the prediction target frame F (0) is the P frame, the P frame or the I frame located in the past direction of the prediction target frame F (0) is set to the reference frame F (−). In the case where the kind of the prediction target frame F (0) is the B frame, any of the P frame, the I frame, and the B frame located in the past direction of the prediction target frame F (0) is set to the reference frame F (−) and any of the P frame, the I frame, and the B frame located in the future direction of the prediction target frame F (0) is set to the reference frame F (+). Normally, the reference frames F (−) and F (+) in the past direction or in the future direction of the prediction target frame F (0) are the closest frame, however, they may be in plurality as the case may be.

Next, the block search unit 26 sets one pixel block B (n) obtained by dividing the prediction target frame F (0) into M pixel blocks B (i) (i=0, 1, 2, . . . , M−1) of a predetermined size as the prediction target block in accordance with a predetermined configuration (initial setting) and reads the data of the prediction target block B (n) from the frame memory 21 (S104). An index i of the pixel block B (i) is allocated sequentially from that in the top-left corner of the prediction target frame F (0) toward the raster scanning direction and the block search unit 26 selects the prediction target block B (n) in order from the smallest index n in each iteration.

Next, the MVP operation unit 23 calculates the motion vector predictor (MVP) for the prediction target block B (n) by using the already-calculated motion vector stored in the motion vector storage unit 22 (S105). As the calculation method of MVP, the calculation method used generally in the MPEG-4 standards is used. In the case where there is no already-calculated motion vector, MVP is set to the 0 vector.

Next, the search range setting unit 25 assigns the size of the search range (SR) in the reference frame F (−) or F (+) by the AASRA scheme for the prediction target block B (n) (S106). Hereinafter, the SR size in the reference frame F (−) direction for the prediction target block B (n) is denoted by SR (n, −) and the SR size in the reference frame F (+) direction is denoted by SR (n, +). Details of the SR assignment processing are described later.

Next, the search center setting unit 24 sets the search center for the reference frame F (−) or F (+) (S107). In the case of the search range SR. L whose SR (n, −) or SR (n, +) is relatively large, the search center for the search direction is set to one of the 0 vector and MVP in the search direction. It is possible to freely select one of them by the configuration. In the case of the search range SR. S whose SR (n, −) or SR (n, +) is relatively small, the search center for the search direction is set to MVP in the search direction. It is possible to freely set the size of SR. L and SR. S by the configuration.

Next, the block search unit 26 sets the search range of the size SR (n, −) or SR (n, +) by taking the set search center as a reference in one of or both the reference frames F (−) and F (+) (S108), performs block matching by the full-search within the set search range, and searches for a reference block that most approximates the prediction target block B (n) (S109). The block matching is performed in accordance with the normal method and for the determination of approximation, the square error sum or the absolute value error sum between each pixel of both the blocks (prediction target block and reference block) is used basically. The block search unit 26 saves the vector to the reference block BR (n) searched for from the prediction target block B (n) in the motion vector storage unit 22 as the motion vector MV (n).

Next, the block search unit 26 determines whether the motion estimation processing is completed for all the pixel blocks B (1) to B (M) in the prediction target frame F (0) (S111) and if not completed yet, the procedure returns to step S104 and if completed, the procedure proceeds to the next step S112.

Next, the block search unit 26 determines whether the motion estimation processing is completed for all the frames in the video sequence between the neighboring I frames (S112) and if not completed yet, the procedure returns to step S101 and if completed, the motion estimation processing is exited.

Next, details of the SR assignment processing at step S106 described above are explained.

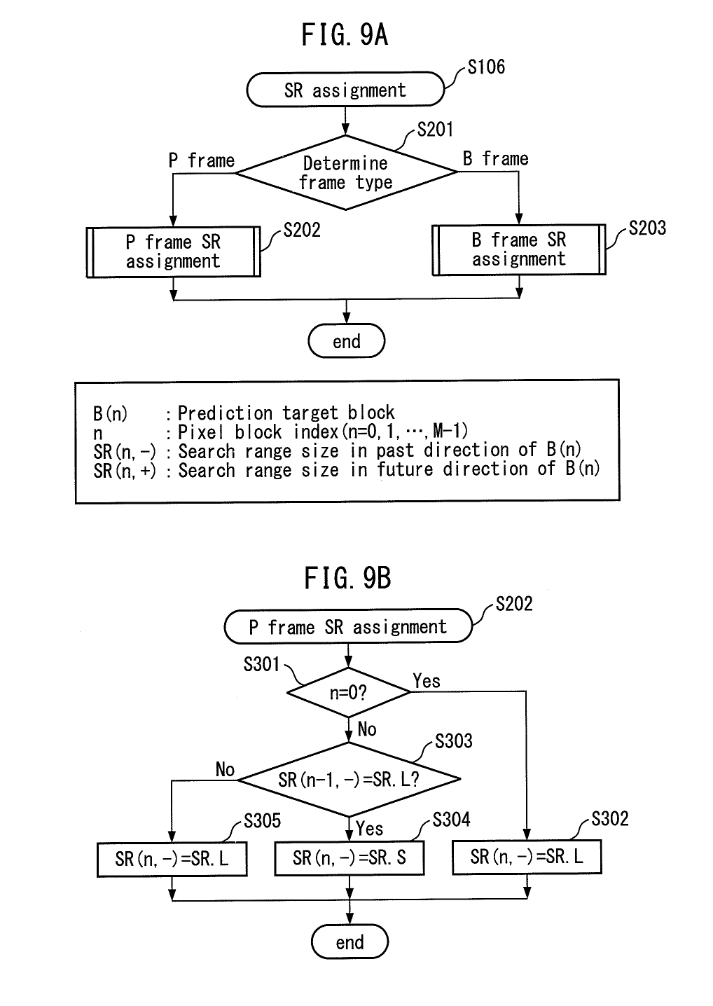

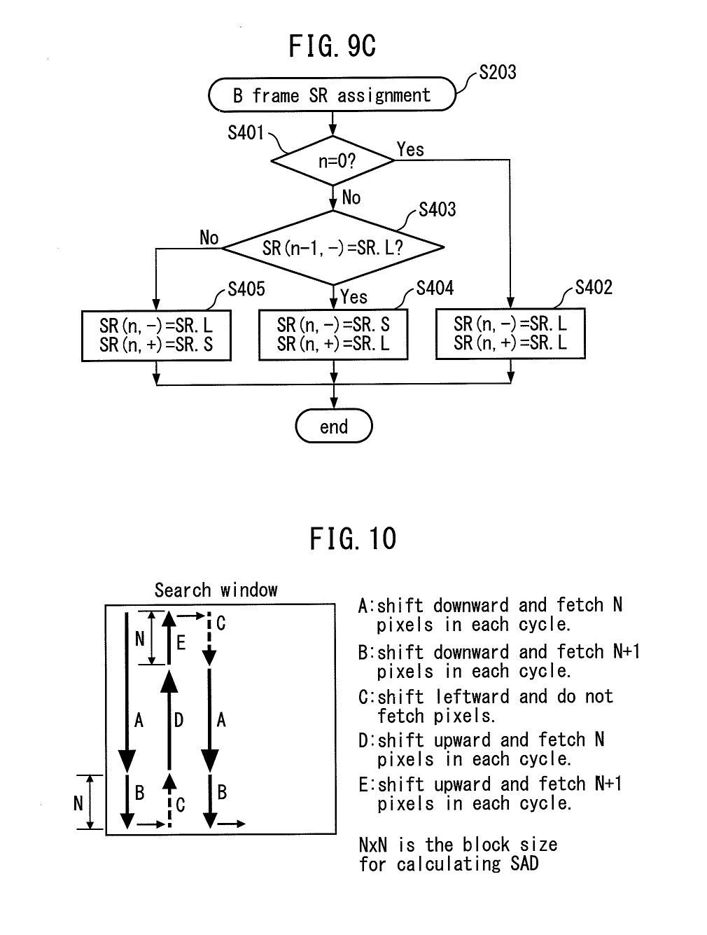

FIG. 9A to FIG. 9C are a flowchart showing the SR assignment processing in FIG. 8 (S106).

In FIG. 9A, first, the search range setting unit 25 determines whether the prediction target frame F (0) is the P frame or the B frame (S201) and in the case of the P frame, performs the P frame SR assignment processing in FIG. 9B (S202) and in the case of B frame, performs the B frame SR assignment processing in FIG. 9C (S203), and thereby, sets the size SR (n, −) or SR (n, +) of the search range.

In the P frame SR assignment processing (S202) (FIG. 9B), first, the search range setting unit 25 determines whether or not the index n of the prediction target block B (n) is 0 (S301) and in the case where n=0, sets SR (n, −) to SR. L (S302). On the other hand, in the case where n>0, the search range setting unit 25 determines whether or not the size SR (n−1, −) of the search range set in the pixel block B (n−1) one before is SR. L (S303) and in the case where SR (n−1, −)=SR. L, sets SR (n, −) to SR. S (S304) and in the case where SR (n−1, −)=SR. S, sets SR (n, −) to SR. L (S305). In the manner as described above, assignment of the search range size by the AASRA-P scheme as illustrated in FIG. 3 is performed.

On the other hand, in the B frame SR assignment processing (S203) (FIG. 9C), first, the search range setting unit 25 determines whether or not the index n of the prediction target block B (n) is 0 (S401) and in the case where n=0, sets both SR (n, −) and SR (n, +) to SR. L (S402). The reason is that MV of any pixel block is not set yet in the case where n=0, and therefore, prediction of MVP, which is the search center of SR. S, cannot be performed. On the other hand, in the case where n>0, the search range setting unit 25 determines whether or not the size SR (n−1, −) of the search range set in the pixel block B (n−1) one before is SR. L (S403) and in the case where SR (n−1, −)=SR. L, sets SR (n, −) to SR. S and SR (n, +) to SR. L (S404). In the case where SR (n−1, −)=SR. S, the search range setting unit 25 sets SR (n, −) to SR. L and SR (n, +) to SR. S (S405). In the manner as described above, assignment of the search range size by the AASRA-B scheme as illustrated in FIG. 1 is performed.

(4) Analysis of Hardware Complexity

Next, in order to verify the effect of the present invention, evaluation of the degree of complexity in the case where the motion estimation device 8 of the present embodiment is applied to a hardware architecture is described. In a hardware architecture consisting of a processing element (PE) and a memory, complexity is not necessarily in simple proportion to the number of search points. Because of this, in order to analyze and verify the effect in order to reduce complexity in the hardware architecture of the present invention, as an example, analysis is conducted by using the snake scan based architecture (Non-Patent document 21).

The snake scan is a widely-used memory access method used in the full-search ME. As illustrated in FIG. 10, in the snake scan, five basic steps (A to E) as below are performed repeatedly to update the shifter register array storing reference blocks.

A: Shift downward and fetch N pixels in each cycle.

B: Shift downward and fetch N+1 pixels in each cycle.

C: Shift leftward and do not fetch pixels.

D: Shift upward and fetch N pixels in each cycle.

E: Shift upward and fetch N+1 pixels in each cycle. N clock cycles are required to preload one pixel block of N×N pixels and after the N clock cycles, the shifter register array outputs data necessary for one search point per cycle to PE. For a search window having (2SR+1)² search points, a number T_{SR} of necessary processing cycles will be expressed by equation (1) below.

T_{SR}=(2SR+1)²+N−1 (1)

If it is assumed that one reference frame is used in each search direction and the size of the pixel block is N×N pixels, 2T_{SR} clock cycles are required to perform the bidirectional search in each pixel block in representative bilaterally symmetric SR assignment (SR assignment in the full-search ME of the B frame).

In light of that the snake scan method does not impose restrictions on SR, it may also be possible to configure and design the ME architecture so as to support a plurality of SRs. Consequently, in the case where the same hardware design is used, the number of processing cycles necessary for AASRA-B is equal to T_{SR. L}+T_{SR. S}. If it is assumed that SR. L=SR and SR. S=λSR (λ<1), a processing time reduction ratio Δc in the case where AASRA-B is applied will be expressed by equation (2) below.

$$\begin{matrix}Δ c = 1 - ( {T}_{SR . L} + {T}_{SR . S )} / 2 {T}_{SR} \\ = 1 - ( {T}_{SR} + {T}_{λ SR )} / 2 {T}_{SR} \\ = 0.5 - ( {( 2 λ SR + 1 )}^{2} + N - 1 ) / 2 ( {( 2 SR + 1 )}^{2} + N - \\ = 0.5 - {λ}^{2} / 2 , when {SR}^{2} >> N\end{matrix} \qquad ( 2 )$$

Since the same hardware is used in both of the methods, the processing time can be regarded as equivalent to the complexity. If is it assumed that SR=128, λ=0.25, and N=16, the complexity reduction ratio of AASRA-B is substantially the same as the reduction ratio of the number of search points, that is, 46% or more.

The complexity reduction ratio in the hardware architecture of AASRA-P is the same as that in the case of AASRA-B.

(5) Coded Bit Rate

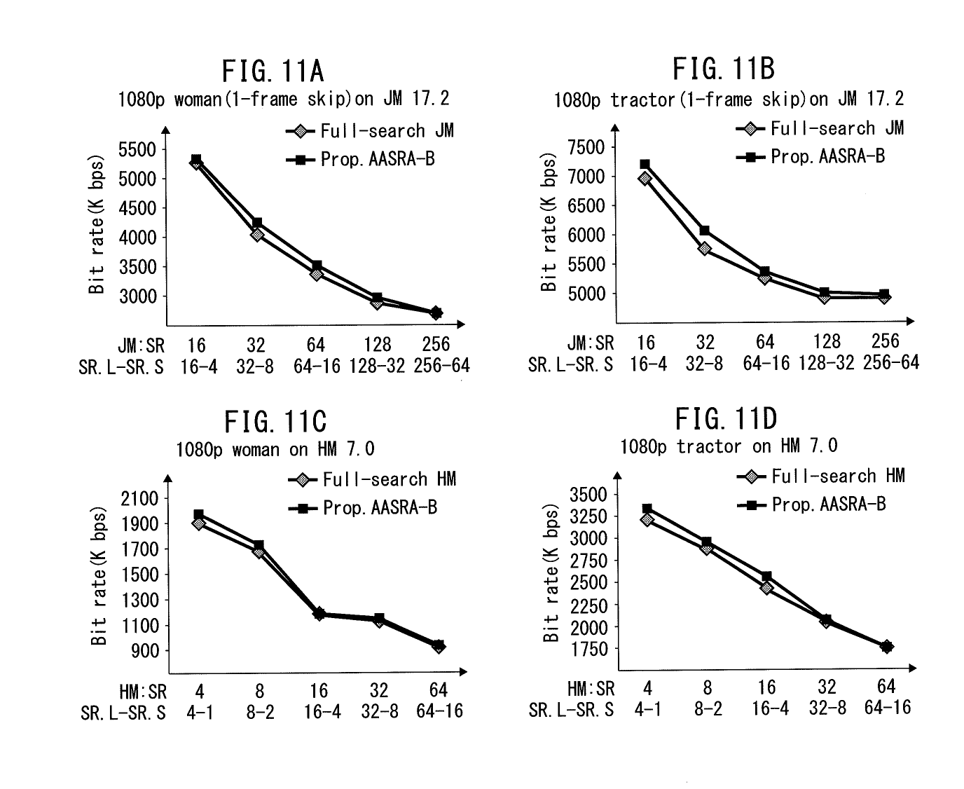

FIG. 11A to FIG. 11D are graphs of changes in the coded bit rate in the case where the SR size is varied in the video encoder using the motion estimation device using the full-search ME and the motion estimation device of the present embodiment. As software of the full-search ME for comparison, JM (Non-Patent document 19) and HM (Non-Patent document 20) are used. JM is configured by the frame structure of IBBBP (I frame, B frame×3, P frame). HM is configured by the hierarchical B structure whose GOP (Group of Picture) size is 8. For JM and HM, one and two reference frames are used in the P frame and the B frame, respectively. Further, the quantization parameter QP=32.

In the motion estimation device of the present embodiment, SR. S is set to ¼ of SR. L. This reduces the degree of complexity by 46.875% (=(1−(¼)²)/2) in terms of the number of search points compared to the full-search ME in the case where SR=SR. L is set. On the other hand, the curves of the coded bit rate are close to one another between JM and HM, and AASRA-B. Consequently, it is possible to evaluate that the motion estimation device of the present embodiment can achieve substantially the equivalent performance in coding efficiency as that of the motion estimation device using the full-search ME.

Next, a motion estimation device of a second embodiment is explained.

(2) Configuration and Operation of Motion Estimation Device

In the present embodiment, an example is explained, in which assignment of the search range (SR) is performed based on the AASRA-PB scheme for the B frame (bidirectional prediction frame). It is assumed that the block configuration of the motion estimation device 8 is the same as that in FIG. 7.

In the following, the pixel block in the prediction target frame F (0) is divided into units of block pairs, which is a pair of an odd-numbered pixel block and an even-numbered pixel block adjacent thereto, and the block pair including the prediction target block is referred to as a prediction target block pair.

The search range setting unit 25 in the present embodiment performs assignment of the search range (SR) based on the AASRA-P scheme for the P frame (see the first embodiment). On the other hand, the search range setting unit 25 performs assignment of the search range (SR) based on the AASRA-PB scheme for the B frame. In other words, in the case where the prediction target frame F (0) is the B frame, the search range setting unit 25 sets the search range SR. S to both the reference frames F (−) and F (+) for one of the prediction target blocks in the prediction target block pair, and sets the search range SR. L to one of the reference frames F (−) and F (+) and sets the search range SR. S to the other for the other prediction target block. Further, the search range setting unit 25 switches assignment of the search ranges SR. S and SR. L sequentially so that the combinations (of the parity and the search direction) of the prediction target blocks to which the search range SR. L is assigned in the prediction target block pair are all different between the four successive prediction target block pairs.

Next, the operation of the motion estimation device 8 of the present embodiment is explained below. The general operation of the motion estimation device is the same as that in FIG. 8 and is already explained in the first embodiment, and therefore, explanation thereof is omitted. As for the search range assignment processing, the processing flow in FIG. 9A is the same as that in the first embodiment. Consequently, only the search range assignment processing for the P frame and the B frame (corresponding to S202 and S203 in FIG. 9A) is explained. In the present embodiment, assignment of the search range is performed in units of block pairs, and therefore in FIG. 8, it is required to read “block pair” instead of “pixel block” and “prediction target block pair” instead of “prediction target block”.

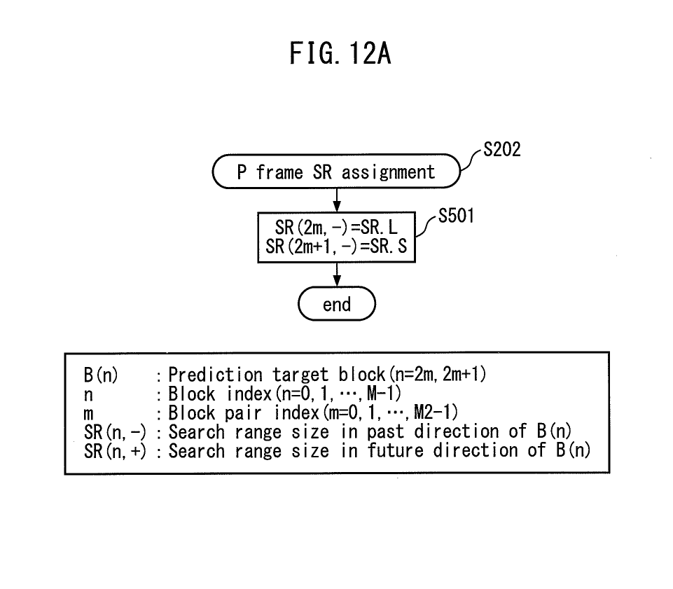

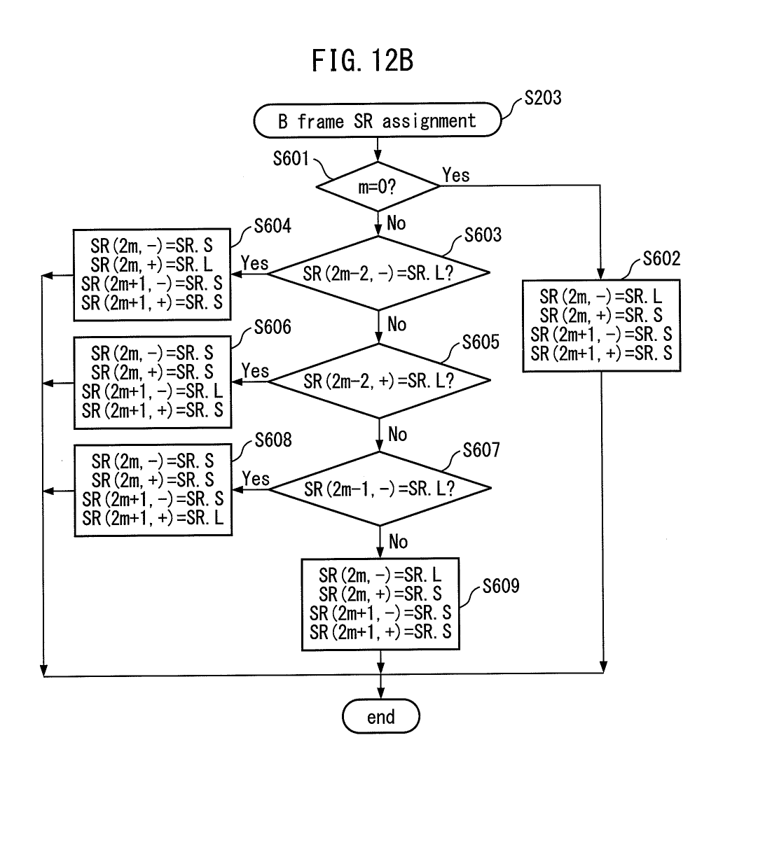

FIG. 12A and FIG. 12B are flowcharts showing the search range assignment processing for the P frame and the B frame in the motion estimation device 8 according to the second embodiment. FIG. 12A is a flowchart showing the search range assignment processing for the P frame and is the same as the processing in FIG. 9B except only in that the processing is performed in units of block pairs instead of pixel blocks, and therefore, the contents of the actual processing are very much the same as those of the processing in FIG. 9B.

FIG. 12B is a flowchart showing the search range assignment processing for the B frame. In the B frame SR assignment processing (S203), first, the search range setting unit 25 determines whether or not an index m of the prediction target block pair is 0 (S601) and in the case where m=0, sets SR (2m, −) to SR. L, and SR (2m, +), SR (2m+1, −), and SR (2m+1, +) to SR. S (S602). In the case where m=0, MV of any pixel block is not set yet, and therefore, MVP, which is the search center of SR (2m, +), is set to (0, 0) (MVP=(0, 0). Different from the first embodiment, SR (2m, +) is set to SR. S, not to SR. SL, in order to achieve a fixed computation rate by setting the number of SR. Ls to one in all the block pairs so that the computational complexity becomes equivalent among all the block pairs.

On the other hand, in the case where m>0, the search range setting unit 25 determines whether or not the size SR (2m−2, −) of the search range set in the pixel block B (2m−2) of the block pair one before is SR. L (S603) and in the case where SR (2m−2, −)=SR. L, sets SR (2m, −), SR (2m+1, −), and SR (2m+1, +) to SR. S and sets SR (2m, +) to SR. L (S604).

In the case where SR (2m−2, −)=SR. S at S603, the search range setting unit 25 determines whether or not the size SR (2m−2, +) of the search range set in the pixel block B (2m−2) of the block pair one before is SR. L (S605), and in the case where SR (2m−2, +)=SR. L, sets SR (2m, −), SR (2m, +), and SR (2m+1, +) to SR. S and sets SR (2m+1, −) to SR. L (S606).

In the case where SR (2m−2, +)=SR. S at S605, the search range setting unit 25 determines whether or not the size SR (2m−1, −) of the search range set in the pixel block B (2m−1) of the block pair one before is SR. L (S607), and in the case where SR (2m−1, −)=SR. L, sets SR (2m, −), SR (2m, +), and SR (2m+1, −) to SR. S and sets SR (2m+1, +) to SR. L (S608).

In the case where SR (2m−1, −)=SR. S at S607, the search range setting unit 25 sets SR (2m, +), SR (2m+1, −), and SR (2m+1, +) to SR. S and sets SR (2m, −) to SR. L (S609).

In the manner as described above, assignment of the search range size by the AASRA-PB scheme illustrated in FIG. 4 and FIG. 5 is performed.

(2) Hardware Complexity Analysis

Next, in order to verify the effect of the present invention, evaluation of the degree of complexity in the case where the motion estimation device 8 of the present embodiment is applied to the hardware architecture is described. As in the first embodiment, in the case where the snake scan method is applied, the number of necessary processing cycles per pixel block pair in the AASRA-PB scheme is T_{SR. L}+3T_{SR. s}. On the other hand, the number of necessary processing cycles per pixel block pair in the full-search ME in which the search range size is fixed to SR. L is 4T_{SR. L}. Consequently, the processing time reduction ratio Δc in the case where AASRA-PB is applied will be expressed by equation (3) below.

$$\begin{matrix}Δ c = 1 - ( {T}_{SR . L} + 3 {T}_{SR . S} ) / 4 {T}_{SR} \\ = 1 - ( {T}_{SR} + 3 {T}_{λ SR} ) / 4 {T}_{SR} \\ = 0.75 - 3 ( {( 2 λ SR + 1 )}^{2} + N - 1 ) / 4 ( {( 2 SR + 1 )}^{2} + N - 1 ) \\ \approx 0.75 - 3 {λ}^{2} / 4 , when {SR}^{2} >> N\end{matrix} \qquad ( 3 )$$

Since the same hardware is used in both the methods, the processing time can be regarded as equivalent to the complexity. If is it assumed that SR=128, λ=0.25, and N=16, the complexity reduction ratio of AASRA-PB is substantially the same as the reduction ratio of the number of search points, 70% or more.

Next, a motion estimation device of a third embodiment is explained.

(1) Principle and Computational Complexity Analysis

In the present embodiment, an example is explained, in which the motion estimation technique according to the present invention is combined with the publicly-known ME architecture other than the full-search ME. The motion estimation technique according to the present invention can be applied to already-existing various kinds of algorithms and various kinds of architectures and it is possible to further reduce complexity. In the present embodiment, an example is explained, in which the motion estimation technique according to the present invention is combined with the MB-parallel data reuse scheme (IMNPDR) (Non-Patent document 18).

IMNPDR is the technique developed in order to reduce the bandwidth of the on-chip memory and in particular, this can reduce the SRAM region and power consumption in a high-throughput video encoder. The basic concept of IMNPDR is that ME is performed simultaneously for a plurality of MBs so that the memory traffic at the portion where the search windows overlap can be shared. In IMNPDR for coding of H.264/AVC 1080p, in the case where four MBs are subjected to parallel operation, the SR size is set to 32 in the representative setting.

As one of the problems when applying AASRA-B to IMNPDR, there is a problem that MBs subjected to parallel processing have to share the same relative search center. In the original IMNPDR, the zero-center ME (ME with (0, 0) as its search center) is always performed, and therefore, this is not problematic. In AASRA-B, the zero-center ME can be applied in the SR. L direction. However, as described above, in ME in the SR. S direction, it is necessary to use a search center (MVP etc.) with higher precision given by each MB for which MV is calculated earlier, and therefore, the search center becomes dynamic for each MB.

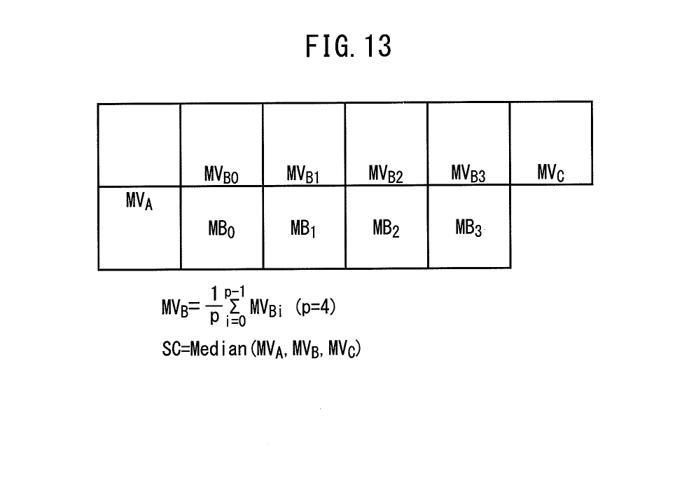

In order to solve the abovementioned problem, in the case where AASRA-B is applied to IMNPDR, for SR. S in MB subjected to parallel processing, the same motion vector predictor determined as in FIG. 13 is used. In other words, in the case where the block set of four MBs (MB₀, MB₁, MB₂, MB₃) is subjected to parallel processing in FIG. 13, MV_{A} on the left side of the block set, MV_{C} on the upper-right side, and an average MV_{B} of four MVs (MV_{B0}, MV_{B1}, MV_{B2}, MV_{B3}) on the upper side are used and the median of three MVs (MV_{A}, MV_{B}, MV_{C}) is taken as a vector SC pointing at the search center of each MB of the block set. That is,

MV_{B}=1/p^{p-1}Σᵢ₌₀MV_{Bi}(p=4) (4a)

SC=Median(MV_{A},MV_{B},MV_{C}) (4b),

where p is the number of MBs subjected to parallel processing and p=4. It is possible to appropriately change the number p of MBs subjected to parallel processing.

It is assumed that the four MBs (MB₀, MB₁, MB₂, MB₃) have SR of the same size in the same reference direction and SR. S is assigned to one direction and SR. L is assigned to the other. Switching of assignment between SR. S and SR. L is performed once for each block set (four MBs). Due to this, it is possible to apply AASRA-B to IMNPDR while guaranteeing the dynamic characteristics of the SR. S search.

Following the snake scan, the number of cycles of IMNPDR necessary for the operation of p MBs in parallel is expressed by equation below.

T_{SR}=(2SR+1)−(2SR+1+(P−1)·N)+N−1 (5)

The additional number of cycles for the number of cycles of the original snake scan (equation (1)) originates from the partial PE idle time for the portion where the search windows do not overlap. If the equation (2) is substituted in the equation (5) on the assumption that SR=32, SR. L=SR, SR. S=0.25SR, p=4, and N=16, the reduction ratio of the number of cycles and the complexity by applying AASRA-B based on IMNPDR is about 43%.

It is possible to regard AASRA-P as AASRA-B performed in the single reference direction, and therefore, it is possible to apply AASRA-P to IMNPDR as AASRA-B and to achieve the same reduction ratio of complexity for the P frame.

When applying AASRA-PB to IMNPDR, as in the method illustrated in FIG. 13, four neighboring MBs are regarded as an MB group sharing the vector SC pointing at the same search center. An MB group pair is configured for each of two successive MB groups. Then, as in FIG. 5, by performing switching of assignment of SR. L once for each MB group pair, AASRA-PB can be implemented. If the equation (3) is substituted in the equation (5) on the assumption that SR=32, SR. L=SR, SR. S=0.25SR, p=4, and N=16, the reduction ratio of the number of cycles and the complexity by applying AASRA-PB based on IMNPDR is about 64%.

(2) Specific Configuration and Operation of Motion Estimation Device

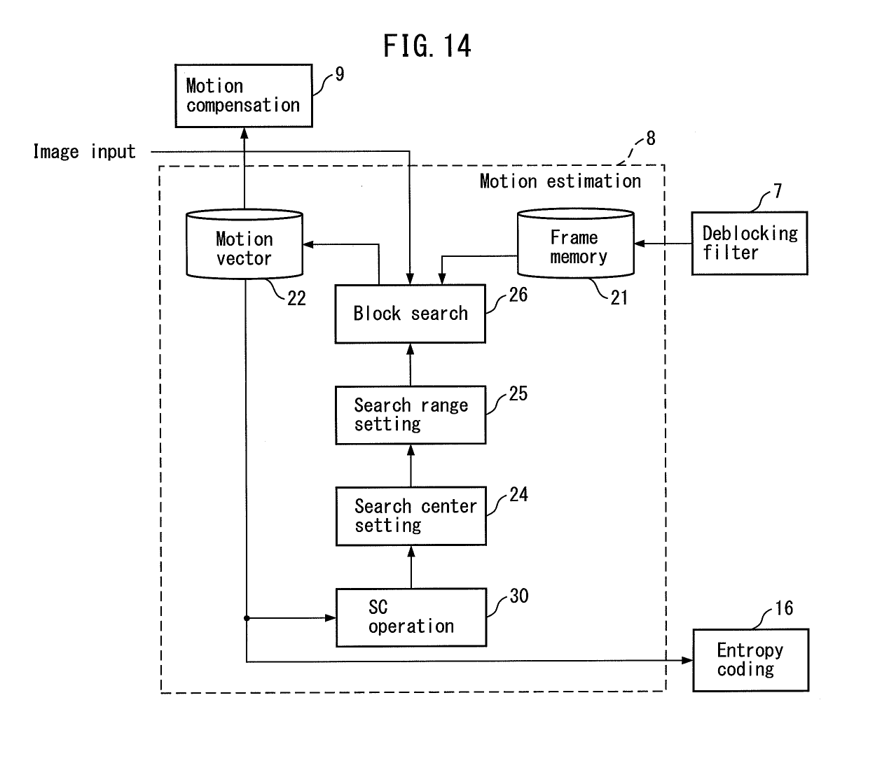

FIG. 14 is a block diagram illustrating a configuration of the motion estimation device according to the third embodiment of the present invention. The motion estimation device 8 includes the frame memory 21, the motion vector storage unit 22, a search center (SC) operation unit 30, the search center setting unit 24, the search range setting unit 25, and the block search unit 26. The frame memory 21 and the motion vector storage unit 22 are the same as the corresponding components in FIG. 7.

As illustrated in FIG. 13, the SC operation unit 30 takes the four horizontally successive prediction target blocks as one prediction target block group and for each prediction target block group, calculates the search center vector SC pointing at the search center of each prediction target block of the prediction target block group from MVs (MV_{A}, MV_{B0}, MV_{B1}, MV_{B2}, MV_{B3}, MV_{C}) of the block for which MV estimation is completed earlier of the blocks neighboring the prediction target block group by using the equations (4a) and (4b).

The search center setting unit 24 sets the search center in each reference direction by the search center vector SC for the prediction target block (MB₀, MB₁, MB₂, MB₃) in the prediction target block group.

The search range setting unit 25 sets the search range with the search center set by the search center setting unit 24 as a center for the prediction target block (MB₀, MB₁, MB₂, MB₃) in the prediction target block group. At this time, assignment of the search range size in each reference direction of each prediction target block is performed by AASRA-P for the P frame and by AASRA-B for the B frame.

Each block search unit 26 searches for a reference block that most approximates each prediction target block and determines a motion vector in the search range in which parallel processing is performed on each prediction target block (MB₀, MB₁, MB₂, MB₃) and which is set for each prediction target block by the search range setting unit 25. The determined motion vector is stored in the motion vector storage unit 22.

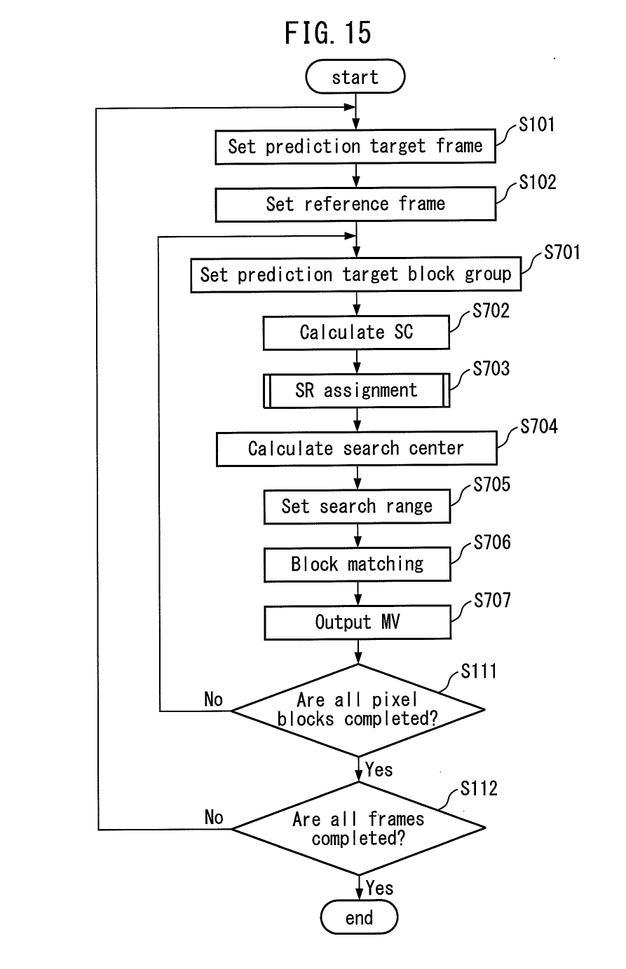

The operation of the motion estimation device 8 according to the present embodiment configured as above is explained below. FIG. 15 is a flowchart showing the general operation of the motion estimation device according to the third embodiment.

In FIG. 15, processing at steps S101 to S102 and S111 to S112 is the same as that at corresponding steps in FIG. 8, and therefore, explanation is omitted.

After step S102, the block search unit 26 divides the prediction target frame F (0) into M pixel blocks B (i) (i=0, 1, 2, . . . , M−1) of a predetermined size in accordance with a predetermined configuration (initial setting), sets four successive prediction target blocks B (4n), B (4n+1), B (4n+2), and B (4n+3) as prediction target blocks, and reads data of the four successive prediction target blocks B (4n), B (4n+1), B (4n+2), and B (4n+3) from the frame memory 21 (S701). Here, n(=0, 1, 2, . . . , M/4−1) is the group number. These four prediction target blocks are taken as the prediction target block group GB (n)={(4n), B (4n+1), B (4n+2), B (4n+3)}. The index i of the pixel block B (i) is allocated sequentially from that in the top-left corner of the prediction target frame F (0) toward the raster scan direction, and the block search unit 26 selects the prediction target block B (i) in order from the smallest index i in each iteration.

Next, the SC operation unit 30 calculates the search center vector SC for the prediction target block group GB (n) by using the already-calculated motion vector stored in the motion vector storage unit 22 (S702). The calculation processing of the search center vector SC is performed by the method illustrated in FIG. 13 and expressed by the equations (4a) and (4b). MV of (MV_{A}, MV_{B0}, MV_{B1}, MV_{B2}, MV_{B3}, MV_{C}) for which the already-calculated motion vector does not exits is set to the 0 vector and substituted in the equations (4a) and (4b).

Next, the search range setting unit 25 performs assignment of the search range (SR) size in the reference frame F (−) or F (+) by the AASRA scheme for the prediction target block group GB (n) (S703). Hereinafter, the SR size in the reference frame F (−) direction for the prediction target block group B G (n) is denoted by SR (n, −) and the SR size in the reference frame F (+) direction is denoted by SR (n, +). Details of the SR assignment processing are the same as those in FIG. 9. In FIG. 9, it is only required to read “S703” instead of “S106”, “prediction target block group” instead of “prediction target block”, and “GB (n)” instead of “B (n)”.

Next, the search center setting unit 24 sets the search center for the reference frame F (−) or F (+) in each prediction target block {B (4n), B (4n+1), B (4n+2), B (4n+3)} (S704). In the case of the search range SR. L whose SR (i, −) or SR (i, +) is relatively large, the search center in the search direction is set to one of the 0 vector and the search center vector SC in the search direction. It is possible to freely select one of them by the configuration. In the case of the search range SR. S whose SR (n, −) or SR (n, +) is relatively small, the search center in the search direction is set to the search center vector SC in the search direction. It is possible to freely set the size of SR. L and SR. S by the configuration.

Next, the block search unit 26 sets the search range of the size SR (i, −) or SR (i, +) (i=4n, 4n+1, 4n+2, 4n+3) by taking the set search center as a reference in one of (in the case of the P frame) or both (in the case of the B frame) the reference frames F (−) and F (+) (S705), performs block matching by the full-search within the set search range, and searches for a reference block that most approximates the prediction target block B (i) (S707). The block matching is performed in accordance with the normal method and for the determination of approximation, the square error sum or the absolute value error sum between each pixel of both the blocks (prediction target block and the reference block) is basically used. The block search unit 26 saves the vector to the reference block BR (i) searched for from the prediction target block B (i) in the motion vector storage unit 22 as the motion vector MV (i).

The operations at steps S703 to S707 are performed by parallel processing for each prediction target block {B (4n), B (4n+1), B (4n+2), B (4n+3)}.

In the above configuration of the present embodiment, the example is explained, in which the search range setting unit 25 performs assignment of the search range by AASRA-B for the B frame, however, the configuration may be such that assignment of the search range is performed by AASRA-PB in place of AASRA-B. In this case, details of the SR assignment processing at step S703 in FIG. 15 are the same as those in FIG. 9A,

FIG. 12A, and FIG. 12B. In this case, it is only required to read “S703” instead of “S106” in FIG. 9A, and “prediction target block group” instead of “prediction target block”, “GB (n)” instead of “B (n)”, “block group index” instead of “block index”, and “block group pair index” instead of “block pair index” in FIG. 12A and FIG. 12B.

Next, a motion estimation device of a fourth embodiment is explained.

In the present embodiment, the effect in the case where the motion estimation technique according to the present invention is combined with the hierarchical search architecture is explained. The hierarchical search (see Non-Patent Non-Patent documents 10 and 11) is an effective method for implementing ME in a large search range. The PMRME architecture (Non-Patent document 10) applies three-hierarchy search level based on the original (L0) reference, the 1:4 down-sampling (L1) reference, and the 1:16 down-sampling (L2) reference in order to cover SRs of the size of 8, 32, and 128, respectively. The searches at these levels are performed in parallel in each dedicated circuit. At L1 and L2, ME by the zero search center is performed and at L0, MVP is used as the search center. Because both the SR size and the resolution are taken into consideration, ME at each level approximates to one another in terms of computational complexity.

In the case where the AASRA scheme is applied to PMRME, the search by SR. L is performed at all the three levels. On the other hand, the search by SR. S is performed only for the search at the level L0 that uses MVP originally as the search center. In order match with the SR size of PMRME described above, the setting of the configuration is done so that SR. L=128 and SR. S=8.

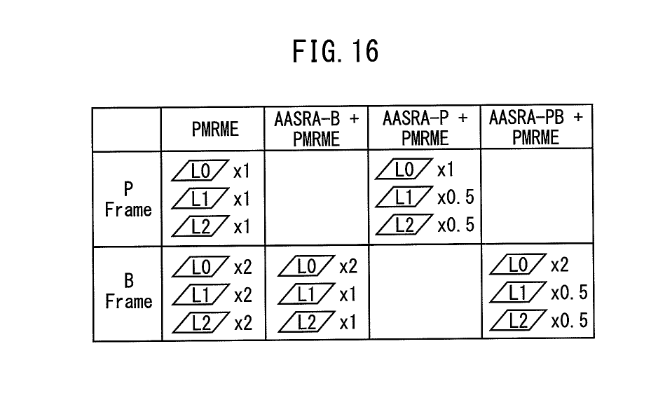

FIG. 16 illustrates relative hardware parallelism necessary to achieve equivalent throughput. It is assumed that the original PMRME for the P frame is a baseline to indicate parallelism. The original PMRME for the P frame requires one-time parallelism at each level. In the case where AASRA-P is applied to PMRME, the levels L1 and L2 are the SR. L search, and therefore, each time the SR. S search at the level L0 is performed twice, the SR. L search at the levels L1 and L2 is performed once, respectively. Consequently, the parallelism at these levels L1 and L2 is regarded as being half the parallelism. If it is assumed that the search at the three-hierarchy level in the original PMRME costs the same hardware, this will result in the reduction in the total complexity by 33%.

In the original PMRME for the B frame, two-time parallelism is necessary at each level for the two reference directions. In contrast to this, in the case where AASRA-B is applied to PMRME, the SR. L search is performed only for one reference direction at the levels L1 and L2, and therefore, one-time parallelism is necessary at these two levels, respectively. As a result of that, compared to the original PMRME, the total complexity is reduced by 33%. In the case where AASRA-PB is applied to PMRME, the parallelism necessary for the levels L1 and L2 is further halved. Consequently, the total complexity is reduced by 50% compared to the original PMRME.

Although the embodiments of the present invention are explained, the embodiments described above are merely for explaining the invention and it is possible for a person skilled in the art to easily understand that there can be various kinds of modified examples in the scope of claims.

What is claimed is:

1. A motion estimation device that performs estimation of a motion vector of a prediction target block included in a prediction target frame, in a motion picture consisting of a plurality of frames arranged side by side in the time order, the prediction target frame being a frame of the plurality of frames for which prediction of a motion vector is performed, and the prediction target block being one of pixel blocks set by dividing the prediction target frame, the motion estimation device comprising:
block search means for searching for a reference block, that most approximates the prediction target block of the prediction target frame, within a predetermined search range in a frame in the past direction relative to the prediction target frame or within a predetermined search range in a frame in the future direction relative to the prediction target frame;
search center setting means for setting a search center when the block search means performs a search regarding the prediction target block in the frame in the past direction and in the frame in the future direction; and
search range setting means for setting the search range around the search center regarding the prediction target block in the frame in the past direction and in the frame in the future direction, wherein
the search range setting means sets a large search range SR. L having a relatively large size or a small search range SR. S having a relatively small size around the search center and switches assignment of the large search range SR. L and the small search range SR. S sequentially between the two neighboring prediction target blocks, and
the search center setting means sets a position identified by a motion vector predictor calculated from a motion vector in a pixel block in the prediction target frame, for which pixel block a motion vector is predicted earlier, as the search center at least for the frame to which the small search range SR. S is assigned by the search range setting means.

2. The motion estimation device according to claim 1, wherein
the search range setting means sets the large search range SR. L to one of the frame in the past direction and the frame in the future direction and sets the small search range SR. S to the other in the case where the prediction target frame is a bidirectional prediction frame, and
the search range setting means further sequentially switches assignment of the large search range SR. L and the small search range SR. S to the frame in the past direction and to the frame in the future direction between two neighboring prediction target blocks.

3. The motion estimation device according to claim 1, wherein
the pixel blocks in the prediction target frame are divided into units of block pairs, which is a pair of an odd-numbered pixel block and an even-numbered pixel block adjacent thereto, and the block pair including the prediction target block is taken as a prediction target block pair,
the search range setting means sets the small search range SR. S to both the frame in the past direction and the frame in the future direction for one of the prediction target blocks in the prediction target block pair, and sets the large search range SR. L to one of the frame in the past direction and the frame in the future direction and sets the small search range SR. S to the other for the other prediction target block in the case where the prediction target frame is a bidirectional prediction frame, and
the search range setting means further switches assignment of the small search range SR. S and the large search range SR. L sequentially so that the combinations (of the parity and the search direction) of the prediction target blocks to which the large search range SR. L is assigned in the prediction target block pair are different between all the four successive prediction target block pairs.

4. The motion estimation device according to claim 1, wherein
p (p is an integer not less than 2) successive pixel blocks are taken to be one set of block group and the block set including the prediction target block is taken to be a prediction target block group,
the search range setting means switches the assignment of the large search range SR. L and the small search range SR. S sequentially between the two neighboring prediction target block groups, and
the search center setting means sets the same search center for each of the prediction target block groups at least for the frame to which the small search range SR. S is assigned by the search range setting means and at the same time, sets a position identified by a motion vector predictor calculated from a motion vector in a pixel block neighboring the prediction target block group in the prediction target frame and for which a motion vector is predicted earlier than the prediction target block group.

5. The motion estimation device according to claim 4, wherein
the search range setting means sets the large search range SR. L to one of the frame in the past direction and the frame in the future direction and sets the small search range SR. S to the other for the prediction target block in the case where the prediction target frame is a bidirectional prediction frame, and
the search range setting means further sequentially switches assignment of the large search range SR. L and the small search range SR. S to the frame in the past direction and to the frame in the future direction between the two neighboring prediction target block groups.

6. The motion estimation device according to claim 4, wherein
the pixel block group in the prediction target frame is divided into units of block group pairs, which is a pair of an odd-numbered pixel block group and an even-numbered pixel block group adjacent thereto, and the block group pair including the prediction target block group is taken as a prediction target block group pair,
the search range setting means sets the small search range SR. S to both the frame in the past direction and the frame in the future direction for one of the prediction target block groups in the prediction target block group pair and sets the large search range SR. L to one of the frame in the past direction and the frame in the future direction and sets the small search range SR. S to the other for the other prediction target block group in the case where the prediction target frame is a bidirectional prediction frame, and
the search range setting means further switches assignment of the small search range SR. S and the large search range SR. L sequentially so that the combinations (of the parity and the search direction) of the prediction target block groups to which the large search range SR. L is assigned in the prediction target block group pair are different between all the four successive prediction target block group pairs.

7. A storage medium storing an estimation program for making a computer to operate as the motion estimation device according to claim 1.
